(19) United States
(12) Patent Application Publication
(10) Pub. No.: US 2025/0021745 A1
(43) Pub. Date: Jan. 16, 2025

(54) Systems and Methods for Automated Intuitive Document Editing

(71) Applicant: DocJuris Inc., Houston, TX (US)

(72) Inventor: Henal M Patel, Houston, TX (US)

(73) Assignee: DocJuris Inc., Houston, TX (US)

(21) Appl. No.: 18/710,444

(22) PCT Filed: Nov. 3, 2022
(86) PCT No.: PCT/US22/48894

§ 371 Date: May 15, 2024

Related U.S. Application Data
(60) Provisional application No. 63/280,273, filed on Nov. 17, 2021.

(51) Int. Cl. G06F 40/166; G06F 40/103; G06F 40/197

(52) U.S. Cl. CPC G06F 40/166; G06F 40/103; G06F 40/197

(57) ABSTRACT

A system for editing a document by uploading a document, such as an execution copy of a previous agreement, digitally marking up a copy of the document, then exporting an automatically rendered separate document representing the edits made to the execution copy. A method for editing a document to automatically render a separate document in a format representing the changes digitally made to the document. Systems and methods for editing a document including use of a playbook.

### FIELD OF THE INVENTION

The present disclosure relates generally to the field of digital document processing. More particularly, this disclosure relates to methods and systems for digitally preparing, reviewing, and editing documents.

### BACKGROUND

Analyzing and editing documents can be a difficult and time-consuming task prone to errors if not carefully undertaken. In situations where multiple reviewers provide input in the editing process, version control can be difficult and document revisions can easily get confused. Drafters or reviewers may go through a number of revised document versions before a finalized version is accepted by all parties. It is not uncommon for a change made in a document by a drafter to be overlooked, omitted, or reedited in a later version, and if not marked properly, the alteration may not be what the parties intended.

Certain documents, such as legal contracts, introduce additional complexity to the editing process. In the business world, legal contract amendments cannot be avoided. The formal process of amending a contract is necessary because contracts are legally binding. Anytime a change is needed for a contract that has been executed (i.e., signed by the parties), the contract needs to be formally amended to ensure it continues to be binding and, therefore, enforceable. A contract amendment is required to be written and signed any time the parties that have executed the contract agree to make a change. A contract “Amendment” is a separately signed contract document that refers to an original executed contract or form document. So, when one is editing a contract with written amendments, one can't just go into the original contract document and make changes. Instead, one needs to write a separate Amendment with a translation of a redline.

On the surface, it doesn't seem like contract amendments would be all that difficult. For example, it should be easy to go into a contract and update the terms from ending in December Year X to December Year Y. However, since one cannot go in and directly amend an original contract, the process often requires one to have the contract open in one window and a PDF or Microsoft Office Word™ version of the document open on another screen, where redline translations are added. These translations are a time-consuming process that can easily take several hours for complex contracts. Some entities require drafters to incorporate specific language or ensure certain clauses are addressed depending on the type of agreement.

A need remains for improved techniques to efficiently and effectively review and edit documents.

### SUMMARY

According to an aspect of the invention, a system for editing a document includes at least one processor having instructions to perform digital functions including to: input digital data representing a document to be edited; display an image of the document to be edited on a screen; display on the screen changes made by a user to the document to be edited; digitally track the changes made by the user to the document to be edited to create a virtual document; and using the virtual document, automatically render a separate document in a selected format representing the changes made by the user to the document to be edited.

According to other aspects of the invention, a computer-implemented method for editing a document includes providing software executable by at least one processor, comprising instructions configured to: input digital data representing a document to be edited; display an image of the document to be edited on a screen; display on the screen changes made by a user to the document to be edited; digitally track the changes made by the user to the document to be edited to create a virtual document; and using the virtual document, automatically render a separate document in a selected format representing the changes made by the user to the document to be edited.

In some embodiments, the automatically rendered separate document is in a format selected from among an amendment, a table, a letter, or a contract.

In some embodiments, the automatically rendered separate document comprises a finalized version ready for execution.

In some embodiments, the functions performed by the at least one processor further include a function to automatically designate or permit selective designation of one or more sections of the document to be edited prior to the automatic rendering of the separate document.

In some embodiments, the functions performed by the at least one processor further include a function to export the document to be edited showing the changes as made by the user to the document to be edited.

In some embodiments, the changes made by the user to the document to be edited comprise the insertion, revision, or deletion of data in the document to be edited.

In some embodiments, the changes made to the document to be edited comprise insertion of data selected by the user from a digital playbook.

In some embodiments, the automatically rendered separate document comprises the digital playbook data inserted by the user to the document to be edited.

In some embodiments, the functions performed by the at least one processor further include a function to automatically analyze the document to be edited using a digital playbook.

In some embodiments, the changes digitally made to the document to be edited comprise insertion of data selected by the user based on the automatic analysis using the playbook, and the automatically rendered separate document comprises the data inserted to the document to be edited by the user.

In some embodiments, the functions performed by the at least one processor further include a function to automatically insert information from a selected marker into the separate document.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments disclosed herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows a communication network configuration according to an example of the present disclosure.

FIG. 2 illustrates a conventional manner of editing a document.

FIG. 3 illustrates a system for editing documents according to an example of the present disclosure.

FIG. 4 illustrates a system for editing documents according to an example of the present disclosure.

FIG. 5 is a flow chart illustrating a method for editing a document according to examples of the present disclosure.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, in the interest of clarity all features of an actual implementation may not be described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The following detailed description of exemplary embodiments, read in conjunction with the accompanying drawings, is merely illustrative and is not to be taken as limiting the scope of the invention. It will be understood that as used herein, the terms “digital” and “digitally” define a creation or rendering by means of digital or computer technology.

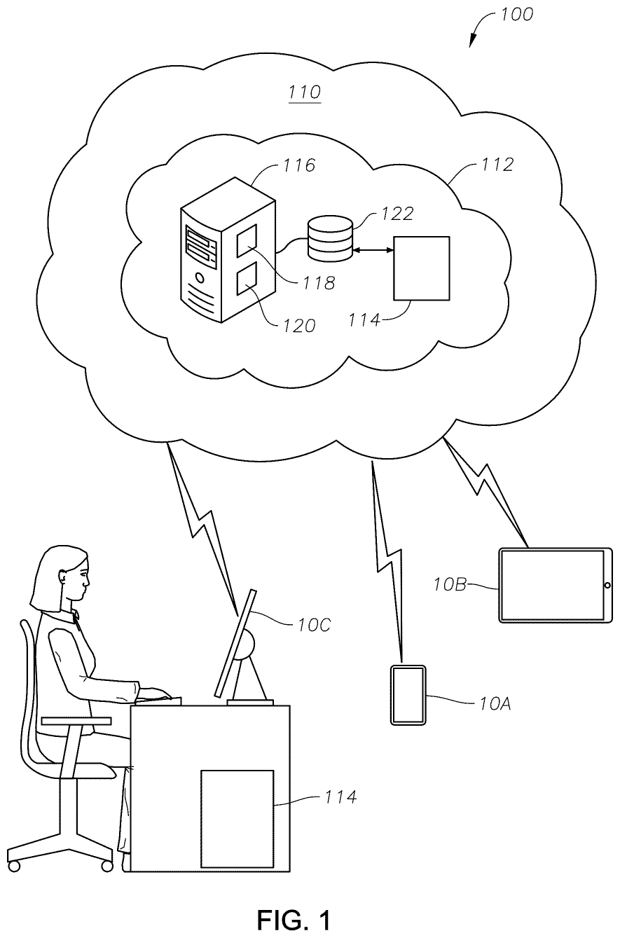

FIG. 1 shows a system 100 consistent with example embodiments of this disclosure. The system 100 includes a communication network 110 that provides communication links between one or more computing devices such as a mobile smart phone 10A, a tablet computer 10B, and a desktop or laptop computer 10C. The computing devices are conventional devices equipped with a visual display. The communication network 110 may be the Internet, an intranet, a wired or wireless network, a Wi-Fi network, a cellular network, or any combination thereof. The system 100 includes architecture 112 including an application module 114, a server 116 configured with one or more processors 118 and a memory module 120 (transitory and non-transitory). Some embodiments may also include a database 122. The architecture 112 may be implemented as a unitary structure (e.g., central server at a main office) or as a cloud-based architecture. Use of the term “cloud” in this context refers generally to conventional cloud computing, which is a paradigm of computing in which dynamically scalable and often virtualized resources may be provided as a service over the network 110.

Some embodiments of this disclosure may also be implemented for operation without direct use of the communication network 110. In such embodiments, the application module 114 is resident in the non-transitory memory of the individual computing devices 10A, 10B, 10C and executable via the internal processor(s) in the devices. Updates to the application module 114 on the computing devices 10A, 10B, 10C could be obtained via the communication network 110 if desired. Embodiments may be implemented using conventional memory constructs (e.g., local memory, virtual memory, and/or cloud-based memory).

The software constructs enabling the embodiments of this disclosure reside in the application module 114. Embodiments of the software code may be implemented using conventional programming languages as known in the art (e.g., JAVA™, PYTHON™, C, C++, etc.). It will be appreciated by those skilled in the art that the application module 114 may be implemented with a single software program or a group of programs designed to perform the activities of the disclosed embodiments. The architecture 112 may be implemented with conventional computer hardware (e.g., server systems) situated in one location or via a distributed cloud-based network.

Those skilled in the art will appreciate that the embodiments of this disclosure may be practiced in network 110 computing environments with many types of computer system configurations, including, desktop computers, laptop computers, personal computers, message processors, hand-held devices, multi-processor systems, microprocessor-based or programmable consumer electronics, network PCs, minicomputers, mainframe computers, and conventional cellphones. Embodiments may also be practiced in distributed system environments where local and remote computer systems, which are linked (either by hardwired data links, wireless data links, or by a combination of hardwired and wireless data links) through a network 110, both perform tasks. In a distributed system environment, application modules 114 may be located in both local and remote memory storage devices.

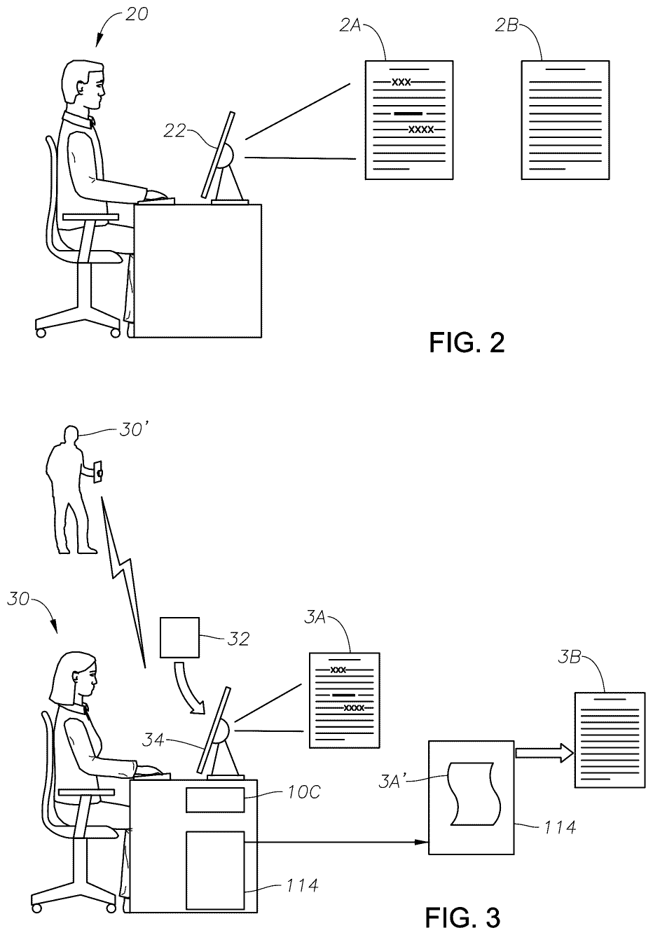

FIG. 2 shows a conventional way of editing documents using conventional software such as Microsoft Word™. A reviewer 20 on a computer 22 pulls up a digital document to be edited and makes common edits (e.g., deleting data, adding data) via the computer keyboard. When editing documents such as legal contracts, a reviewer typically makes the edits using the Track Changes feature in Word™, producing a redlined document 2A viewable on the computer screen. The redlined document 2A can then be distributed to other reviewers so that they can make additional edits to the document as desired. As previously discussed, with multiple reviewers involved, version control can be difficult to maintain and document revisions can easily get confused.

The reviewers may go through a number of revised document versions 2A before a finalized version is accepted by all parties. In the case of executed contracts, once a redline revised version 2A is accepted as a final version, the parties commonly desire to formalize the redline edits made to the edited document 2A via a separate Amendment document to be executed by the parties. An Amendment document 2B is typically drafted by one of the reviewers, using the final version of the edited document 2A as the go-by. A reviewer may flip back and forth on the screen between the edited document 2A file and the Amendment document 2B file to create the Amendment document. This is a very inefficient and time-consuming process, particularly for organizations that execute thousands of legal contracts annually. It is also not uncommon for an Amendment document 2B to be executed by the parties and later discovered to contain errors made by the reviewer that created the document.

FIG. 3 shows an embodiment of this disclosure. A user 30 inputs data 32 representing a document to be edited (e.g., Word™ file, PDF file, etc.) into a computing device such as a computer 10C configured with an application module 114 or linked through the Cloud to the application module as disclosed herein. The data 32 may be digitally transmitted for input to the computing device 10C via the communication network 110 or uploaded locally (e.g., via flash drive, CD, etc.). Once input, the user 30 can digitally make any desired changes (e.g., via the computing device keyboard or conventional dictation software) to the document to be edited 3A comprised in the data 32. The user 30 can mark up the document and add any exhibits as desired. If desired, a user 30 can set ranges for the sections in the document 3A, as further described below. The user 30 can view the edits as they are being made to the document 3A on the screen 34. For example, a user 30 can make desired edits to a document to be edited 3A using a track changes feature in the application module 114, producing a redline version viewable on the screen 34. In the background, the application module 114 automatically renders a separate document 3B representing the changes made by the user to the document to be edited 3A.

An application module 114 embodiment of this disclosure automatically renders the separate document 3B by revisualizing the original document to be edited 3A, creating a virtual document 3A′ by capturing all the key strokes and inputs made by the user 30 to the document to be edited 3A and sending those data points to the virtual document. Some embodiments of the application module 114 may calculate the location of every change and input made to the document to be edited 3A and automatically transform those changes to the virtual document 3A′. Some embodiments of the application module 114 designate the areas of the document to be edited 3A and automatically label corresponding designated areas, sections, or ranges in the virtual document 3A′ to mirror the areas, sections, or ranges as designated or labeled in the document to be edited 3A. For example, a document to be edited 3A might include expressly designated areas or sections, such as a recitals section, numbered paragraphs, sub-numbered lists, multiple exhibits, a signature block, etc. The application module 114 may automatically designate these areas and transfer the designated area data to the virtual document 3A′ in order to ensure the changes represented on the separate document 3B correspond directly with the designated areas, sections, and/or ranges in the document to be edited 3A.

In some embodiments, the user 30 can digitally selectively set or designate the areas to be transferred to the virtual document 3A′ in order to customize the changes represented on the separate document 3B. For example, a document to be edited 3A might have an outlined General Terms and Conditions section, and an Exhibit schedule with a repetitive outline style such that there are multiple “1.2” entries in the document. After uploading the document to be edited 3A, a user can set specific areas in the document as desired. Following with the example, the user can digitally edit the document 3A to designate and set one area as “T&Cs.” After making any desired edits to that section, the document is saved with the expressly set area designation. If the user then sets the other area in the document to be edited 3A and designates it as “Schedule 1,” then the application module 114 will automatically render the separate document 3B with the clearly distinguished preset areas in the text (i.e., T&Cs and Schedule 1). Upon exporting the separate document 3B (e.g., as an Amendment), the separate areas are clearly distinguished.

Once a user 30 has digitally made desired edits to the document to be edited 3A and the separate document 3B has been automatically rendered by the application module 114, the user can view the separate document 3B on the screen 34, save the document as a file, and/or export the separate document as known in the art (e.g., email distribution to all reviewers). The format of the separate document 3B can be selected by the user 30. For example, for documents comprising legal contracts a user 30 can select the format of the separate document 3B from among an Amendment, a table, a letter, a contract, or any other format as desired. It is common in the legal profession for a party to require any proposed edits to a contract to be listed on what is known as an exception table, leaving the original contract document intact. Pre-defined format templates for the separate document 3B, representing and incorporating the changes made to the document to be edited 3A, can reside in the database 122 or other memory location.

Some embodiments of this disclosure allow a user to create a customized form for the separate document 3B. For example, a user may want the automatically rendered separate document 3B to have a specific opening paragraph, some boiler plate text, specifically defined terms, etc. The user can create and save these customized form templates (e.g., as individual information packets or markers). When editing a document 3A, the user can pick one or more desired markers to drop into the document to be edited 3A so that the automatically rendered separate document 3B will include the information from the marker directly in the separate document at the precise location where the user inserted the marker.

There are many reasons why one might need to amend or edit a document, such as a legal contract. In such events, embodiments of this disclosure will automatically render the separate documents 3B (such as a contract Amendment) without the user needing to go through the painstaking process of manually writing redline translations into a new document. Some common, but not limiting, scenarios that come up when parties enter into a contract include:
Term changes. A user might enter into a contract with a company or other party for a certain period of time, such as one year. As it gets close to finishing the time period outlined in the contract, both parties may agree to extend the time period for another year (or any other length of time). In this case, a separate contract Amendment document will be needed to make the contract amendment specifying the new duration of the contract and it will need to be executed by both parties.
Changes to product amounts. A user might sign a contract with a company to purchase a certain amount of products. As time passes and the business scales, the user may decide to buy more products than he had initially agreed to. In this case, a separate contract Amendment document will be needed to amend the contract so that it aligns with the updated number of goods to be purchased, ensuring that the parties abide by their contractual obligations for the duration of your contract term.
Price changes. Supposing a user entered into a contract with a company to buy a set amount of goods for a fixed price. Over time the company begins raising its prices. After alerting the user of the change in prices and ensuring that the user agrees to the pricing increase, a separate contract Amendment document will be needed to amend the contract to reflect the new pricing. The Amendment is then executed by the parties to show a mutual agreement to the price change.
Customer requests. Many businesses don't want to deal with redline versions of edited documents. Instead, customers and vendors might demand that an amendment or exception table be sent over so they can review any changes a user wishes to make to a document and negotiate from there. With embodiments of this disclosure, a user can simply upload the document to be edited 3A for analysis and digitally mark it up as disclosed herein. Once the separate document 3B is automatically produced, the user can export the amendment to have a straightforward document that details the parts of the document to be edited 3A the user would like to negotiate or change.
Rush contracts. Embodiments of this disclosure are ideal for rush contracts. For example, by simply appending a “prevailing terms” exhibit for a sales and procurement team. A user can then send exceptions to the contract in a formatted Amendment to the other side with just one click.

Turning to FIG. 3, in some embodiments, a user 30 can make available the document to be edited 3A to other parties (e.g., user 30′) via the communication network 110. For example, a user 30 can designate a document to be edited 3A and provide another party 30′ a hyperlink (e.g., via email) to the document. The other party or parties 30′ can each make their proposed changes to the document to be edited 3A, whereupon the application module 114 records all the changes as described herein. After the other party (ies) 30′ has made the desired changes to the document to be edited 3A, the user 30 can then access the document(s) (via the application module 114) and select the desired format for the automatically rendered separate document(s) 3B. For example, if the user 30 wishes to view a representation of the changes made to the document 3A by the other party 30′ in the format of an exception table, the user 30 elects that format and the separate document 3B is automatically rendered as such for the user 30 to view and process as disclosed herein.

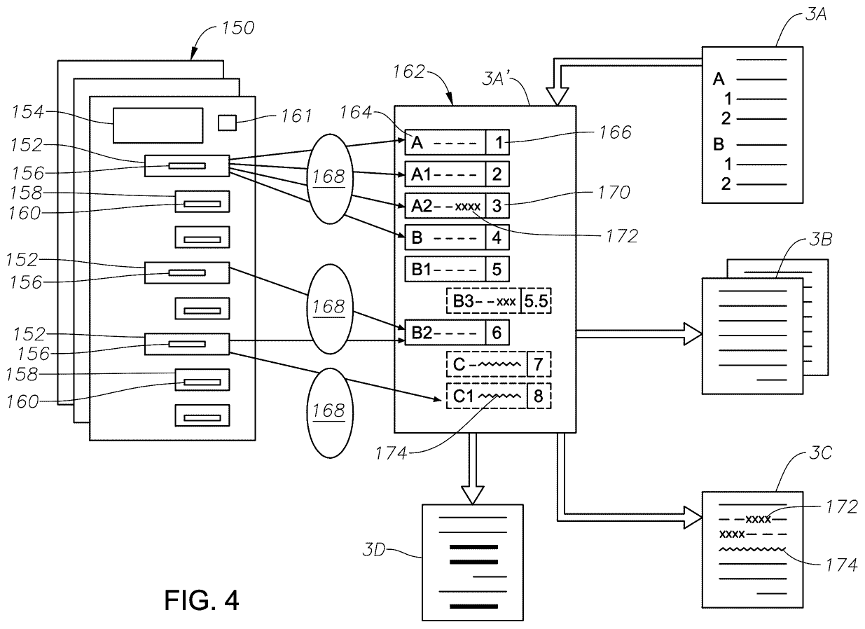

In some embodiments, a user can edit and customize a document to be edited 3A using a playbook. A playbook is a compilation of issues representing items of interest to the user in the review and editing of the particular document. FIG. 4 shows a schematic of a playbook 150 in accordance with this disclosure. In some embodiments, one or more playbooks 150 may be stored in the database 122 or other memory location. A playbook 150 is essentially a customized set of detailed instructions or a checklist that contains issues 152 which provide the user guidance in reviewing/editing a document to be edited 3A. When enabled by a user, the playbook 150 is displayed for the user (e.g., on the screen 34 side-by-side with the document to be edited 3A). Once the playbook 150 is selected by the user, the playbook automatically compares or analyzes the document to be edited 3A against the issues 152 checklist in the respective playbook.

For example, for applications with legal documents an embodiment of this disclosure may comprise a playbook 150 with a compilation of issues 152 common to the legal profession (e.g., preferred positions, counter-party positions, statutory clauses, definitions, etc.). A preferred position may define company standards and organization risk mitigation practice. Counter-party positions may define how a counter party may view an issue and provides guidance on how to respond to the counter position. Examples may be to accept, reject, or offer a different counter to the counter position. Upon opening a playbook 150 comprising legal issues 152 the playbook automatically compares or analyzes the document to be edited 3A against the issues checklist in the playbook.

In some embodiments, a playbook 150 comprises description information 154 and one or more issues 152, each having a preferred position 156. Each issue 152 has associated one or more counter positions 158. Each counter position 158 has guidance 160 for how the counter position should be accepted, rejected, or modified by the user in an attempt to achieve the preferred position 156, or get closer to it such that the final position is acceptable to the parties. FIG. 4 depicts a playbook 150 embodiment including a tab under which the user-established information packets or markers 161 (described above) are saved and can be selected as desired by a user to edit a document 3A.

An original document to be edited 3A is imported and parsed into sections 162, as described herein. The sections 162 are tagged with a unique identifier 164 and an order 166. The sections 162 are associated with issues 152 in the playbook 150 by key phrases or keywords 168. A user may navigate through the document 3A′ sections 162 by selecting issues 152 from the playbook 150, which will show sections 162 associated by the keywords 168 with the issue. If multiple sections 162 are associated with the selected issue 152, then the user can sequentially navigate through each of the sections. As an example, the schematic in FIG. 4 shows that the first issue 152 in the list is associated with the sections tagged as A, A1, A2, and B.

A user may navigate through the document 3A′ by selecting a section 162, which will show the issues 152 from the playbook 150 associated by the keywords 168 with the section 162. If multiple issues 152 are associated with the selected section 162, then the user can sequentially navigate through each of the issues. As an example, the schematic in FIG. 4 shows that section B2 is associated with the second and the third issue 152 in the list.

As a user modifies the sections 162 of the document 3A′, changes are indicated by a status tag 170. The status tag 170 may indicate that text has been edited 172 or that text has been inserted 174. The ordering tags 166 may be modified as sections are inserted or rearranged. As an example, see that section B3 has been inserted between sections 162 with ordering tag 5 and 6, and therefore has an ordering tag 5.5. It will be appreciated that Arabic numbering does not have to be used for tagging with embodiments of this disclosure. As an example, a linked list structure may be utilized to accomplish the same task so that when the user chooses to export or output the separate document 3B, all sections are in order.

As previously discussed, embodiments of this disclosure may produce multiple types of output documents, such as a final formatted ready-to-execute separate document 3B for presentation to the parties, or a redlined copy 3C (indicating edits 172 and inserts 174) of the edited document 3A for use in negotiations, or a private copy 3D which includes notes on guidance and counter positions from the playbook 150 which the user may reference during negotiations.

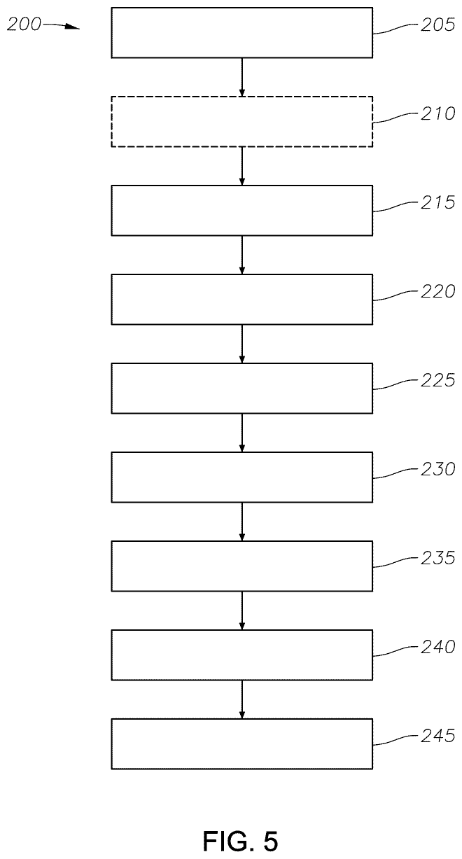

FIG. 5. shows a flowchart of a method 200 for editing a document in accordance with an embodiment of this disclosure. As described herein, inputting or uploading data 32 representing a document to be edited 3A into the system for analysis and editing involves parsing the document 205 to prepare it for manipulation by the user. The input data may comprise an already executed document (e.g., PDF executed contract) or a document in review or negotiation between multiple reviewers.

If the user opts to use a playbook 150, the user selects a playbook 210 appropriate to the document. This is usually dependent on the type of document to be edited 3A. Examples may include, but are not limited to: a nondisclosure agreement; a purchase contact; a service agreement; an equipment lease; a will and testament; a pre-nuptial agreement, a custody agreement, etc. As previously discussed, a user can also define or select a format template (e.g., an Amendment, exception table, acknowledgement letter, or other desired template) in the playbook 150 for the automatically rendered separate document 3B to be generated by the application module 114. If no template is selected, the application module 114 will automatically create the virtual document 3A′ using a pre-established default template.

At step 215, the data comprising the document to be edited 3A is uploaded for analysis. The document is then divided into sections 220 as described herein. Sections can be determined from paragraphs, syntax, grammar, formatting, or style sheets, etc. Sectioning may be automatic or may involve user interaction. For example, the application module 114 may section the virtual document 3A′ based on paragraphs and then display suggested divisions for the sections to the user. The user may then add additional divisions or remove divisions (essentially re-joining one or more sections into a single section). The documents may be displayed on the screen of the peripheral implemented with the particular computing device or a stand-alone video display.

Once the document 3A′ is divided into sections at step 220, any section containing edits from the original document are marked 225. In a typical scenario it is highly likely that a document 3A may contain edits marked from a previous reviewer. Those edits are identified so the reviewer can be notified of the changes and focus on the changed issues. Each section is uniquely tagged to identify and distinguish it from all the others. This is done since a document divided into sections may contain duplicate information, and therefore yield duplicate sections which must be handled individually for further processing. Additionally, each section is identified as to its order or relation to the other sections. Uniquely tagging each section and identifying the order 230 may be a joined process and may be a single label, or it may be two individual processes and may involve multiple identifiers.

When each document section is uniquely identified and ordered, the document is preprocessed 235. Preprocessing involves, but is not limited to: applying edits; standardizing formatting, such as removing bolding, coloring, underling; replacing multiple spaces with tabs, removing metadata, etc. The information may be preserved for re-application upon output of the edited document. Once the document is preprocessed, the document is ready for editing. The playbook 150, if selected, and the parsed document are displayed for editing 240 by the user as disclosed herein. If a playbook 150 was selected, the user can apply the issues 152 and other features of the playbook to edit the document as disclosed herein.

At step 245, a separate document 3B is automatically rendered representing the edits digitally made to the input document to be edited. The user can then elect to display the rendered document on the screen and/or to export the separate document 3B. By application of the disclosed embodiments, a user no longer needs to create the final document (e.g., an Amendment) as the separate document 3B is customized and automatically rendered, ready for execution or finalization as suitable.

In some embodiments, a user can build and scale the playbook(s) 150 via the application module 114. Users can: associate a playbook 150 with a document type (e.g., different contract document types); establish a standard form template in the playbook 150 for comparison and analysis of documents to be edited 3A; create and enter details for issue 152 lists; create and edit customized information markers 161, and update or revise previously created playbooks 150 as desired. Upon opening a document to be edited 3A as disclosed herein, the application module 114 automatically analyzes the document and displays the different form templates in the playbooks 150 associated with the particular document type. The user can select from among the automatically listed form templates or pick another specific form template in the playbook 150 forms glossary. Users can also designate which other users can access, navigate, and/or modify the created playbook(s) 150.

In some embodiments, a core playbook 150 may be established by the user. For example, for contract document editing a core playbook 150 may include standard issues included in essentially every contract (e.g., standard boilerplate language and clauses). A core playbook 150 may be copied as a starting point and edited rather than beginning each playbook from nothing and duplicating work previously done in other playbooks. In some embodiments, a core playbook 150 may be applied along with a transaction specific playbook. Joining two playbooks 150 together and applying the resultant as a single playbook can make it easier to update or change core issues across a wide range of transactions. When joining playbooks 150, a user may include instructions on handling potential conflicts among issues 152 and guidance recommendations.

It will be appreciated by those skilled in the art that the disclosed embodiments may be implemented using conventional software and computer systems programmed to perform the disclosed processes and operations. The present invention may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, or other transmission media (e.g., light pulses passing through a fiber-optic cable).

Computer readable program instructions described herein can be downloaded to respective computing/processing devices from a computer readable storage medium or to an external computer or external storage device via a network 110, for example, the Internet, a local area network, a wide area network, a wireless network, and/or a cloud-based network. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer entirely on the remote computer or server, over a cloud-based network, or via a combination of the foregoing.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In light of the principles and example embodiments described and illustrated herein, it will be recognized that the example embodiments can be modified in arrangement and detail without departing from such principles. For example, alternative embodiments may include processes that use fewer than all of the disclosed operations, processes that use additional operations, and processes in which the individual operations disclosed herein are combined, subdivided, rearranged, or otherwise altered. It will also be appreciated that embodiments of this disclosure may be implemented for use with documents composed of or containing information in any language. In view of the wide variety of useful permutations that may be readily derived from the example embodiments described herein, this detailed description is intended to be illustrative only, and should not be taken as limiting the scope of the invention.

What is claimed is:

1. A system for editing a document, comprising:
at least one processor configured with instructions to perform digital functions including to:
input digital data representing a document to be edited;
display an image of the document to be edited on a screen;
display on the screen changes made by a user to the document to be edited;
digitally track the changes made by the user to the document to be edited to create a virtual document; and
using the virtual document, automatically digitally render a separate document in a selected format representing the changes made by the user to the document to be edited.

2. The system of claim 1 wherein the automatically rendered separate document is in a format selected from among an amendment, a table, a letter, or a contract.

3. The system of claim 1 wherein the automatically rendered separate document comprises a finalized version ready for execution.

4. The system of claim 1 wherein the functions performed by the at least one processor further include a function to automatically designate or permit selective designation of one or more sections of the document to be edited prior to the automatic rendering of the separate document.

5. The system of claim 1 wherein the functions performed by the at least one processor further include a function to export the document to be edited showing the changes as made by the user to the document to be edited.

6. The system of claim 1 wherein the changes made by the user to the document to be edited comprise the insertion, revision, or deletion of data in the document to be edited.

7. The system of claim 1 wherein the changes made to the document to be edited comprise insertion of data selected by the user from a digital playbook.

8. The system of claim 7 wherein the automatically rendered separate document comprises the digital playbook data inserted by the user to the document to be edited.

9. The system of claim 1 wherein the functions performed by the at least one processor further include a function to automatically analyze the document to be edited using a digital playbook.

10. The system of claim 9 wherein the changes made to the document to be edited comprise insertion of data selected by the user based on the automatic analysis using the playbook, and the automatically rendered separate document comprises the data inserted to the document to be edited by the user.

11. The system of claim 1 wherein the function to automatically render the separate document comprises insertion of information from a selected marker into the separate document.

12. A computer-implemented method for editing a document, comprising:
providing software executable by at least one processor, comprising instructions configured to:
input digital data representing a document to be edited;
display an image of the document to be edited on a screen;
display on the screen changes made by a user to the document to be edited;
digitally track the changes made by the user to the document to be edited to create a virtual document; and
using the virtual document, automatically digitally render a separate document in a selected format representing the changes made by the user to the document to be edited.

13. The method of claim 12 wherein the automatically rendered separate document is in a format selected from among an amendment, a table, a letter, or a contract.

14. The method of claim 12 wherein the automatically rendered separate document comprises a finalized version ready for execution.

15. The method of claim 12 wherein the software includes instructions configured to export the document to be edited showing the changes as made by the user to the document to be edited.

16. The method of claim 12 wherein the changes made by the user to the document to be edited comprise the insertion, revision, or deletion of data in the document to be edited.

17. The method of claim 12 wherein the changes made to the document to be edited comprise insertion of data selected by the user from a digital playbook.
